(19) United States
(12) Patent Application Publication
(10) Pub. No.: US 2012/0293142 A1
(43) Pub. Date: Nov. 22, 2012

(54) PHASE-CONTROLLED AC VOLTAGE STABILIZING CIRCUIT

(76) Inventor: Jui-Kun HUANG, Kaohsiung City (TW)

(21) Appl. No.: 13/109,494

(22) Filed: May 17, 2011

(51) Int. Cl. G05F 1/44

(52) U.S. Cl. 323/237

(57) ABSTRACT

A phase-controlled AC voltage stabilizing circuit includes a buffer device connected between an input power side and an exciting side of a transformer to provide flywheel paths of exciting current within the positive half cycle and negative half cycle of input power. A pulse width modulation control device is connected between the buffer device at the exciting side of the transformer and a neutral point of a power supply system to switch ON and OFF a number of times within each half cycle of the input power to allow an inductor to regulate the variable voltage so that waveform of the exciting current of the transformer is smoother. By regulating the voltage at the output side of the transformer, response time of stabilizing voltage is faster and distortion of the waveform is smaller.

### FIELD OF THE INVENTION

The present invention relates to a phase-controlled AC voltage stabilizing circuit and particularly to an AC voltage stabilizing circuit to perform rapid multi-stage pulse width modulation of the input power within each half cycle thereof to be output to resolve the bulky and heavy drawbacks of the voltage stabilizing equipment.

### BACKGROUND OF THE INVENTION

In recent years, rapid technology progress makes all sorts of electronic instruments and precision equipment widely adopted. The equipment can accept merely limited variations of the input power. For instance, voltage swell could cause damage of the utilization equipment, and voltage sag could also cause unstable power utilization. In a power distribution system, each feeder has many users. When the feeder is heavily loaded or disconnected, voltage drop variations on the circuit could cause unstable voltage to the neighboring power utilization equipment. Hence an AC voltage stabilizer is an important device to improve power quality.

Please refer to FIG. 1, a conventional phase-controlled voltage stabilizer has a switch 93 located on an exciting side 91 of a transformer 9. The switch 93 is a thyristor (SCR or TRIAC) which is switched ON to merely adjust the voltage once within each half cycle, hence cannot rapidly stabilize the voltage and reduce harmonic pollution. It also needs a bulky and heavy filter.

### SUMMARY OF THE INVENTION

Therefore, the primary object of the present invention is to provide a phase-controlled AC voltage stabilizing circuit to overcome the poor input power factor on the power source side caused by feedback of current harmonic to a power supply system during voltage stabilizing process of the conventional power voltage stabilizer and the need of designing a low harmonic filter to improve power quality of output voltage that results in a bulky and heavy filter.

To achieve the foregoing object, the invention employs techniques as follows: providing a buffer device to connect an input power side and an exciting side of a transformer. The buffer device has two one-way conduction paths that are in opposite conductive directions. When one one-way conduction path is set ON, the other one-way conduction path is set OFF to respectively provide flywheel path of exciting current within the positive half cycle and negative half cycle for the transformer. Each one-way conduction path includes at least one controllable switch and at least one one-way conduction device coupled in series. A pulse width modulation (PWM in short hereinafter) control device is connected between the buffer device at the exciting side of the transformer and a neutral point of a power supply system. The PWM control device is a semiconductor two-way switch for switching ON and OFF a number of times within each half cycle of the input power. During operation, the input power passes through the one-way conduction path of the buffer device and allows the PWM control device to be switched ON and OFF a number of times within each half cycle so that the voltage at the exciting side of the transformer is regulated to be a variable voltage with several stages. And through filtering of an inductor, the waveform of the exciting current for the transformer is smoother. Moreover, the voltage at the output side is regulated through the transformer, and distortion of output voltage waveform also can be improved through a low-pass filter.

The invention can improve the problems of the conventional AC voltage stabilizing equipment that has slow voltage regulation response time and low power factor at the power input side caused by the current harmonic.

The present invention provides a phase-controlled AC voltage stabilizing circuit that includes a buffer device and a PWM control device to control the input power, and can quickly stabilize the voltage and reduce distortion of the output voltage waveform to solve the bulky and heavy problems of the filter.

In short, the invention adopts the PWM control method and provides many advantages, notably:

1. Total volume of the voltage stabilizing equipment is smaller and lighter.

2. Faster response for transient regulation of the output voltage.

3. Smaller distortion of the output voltage waveform.

4. Reduce current harmonic pollution feeding back to the power supply system.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit diagram of a conventional phase-controlled voltage stabilizing equipment.

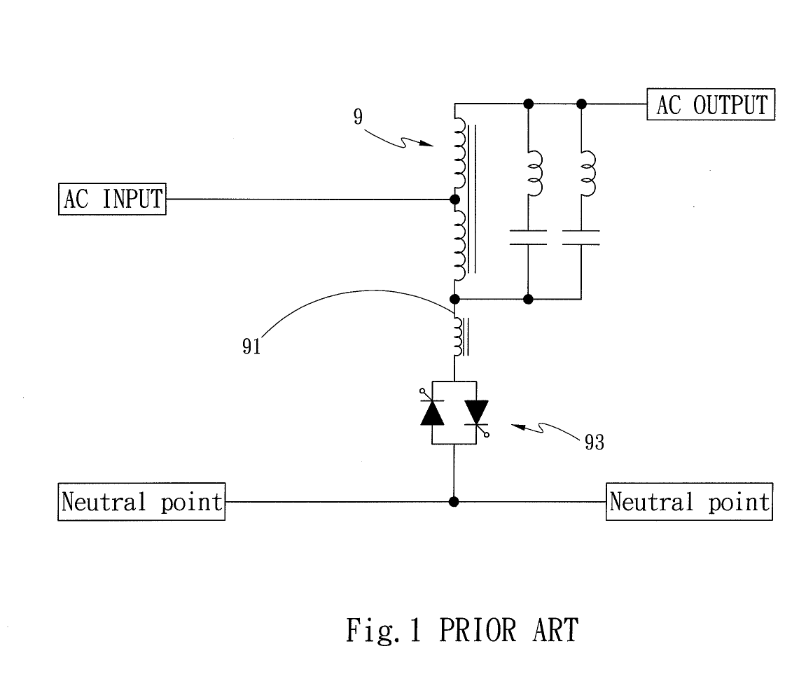

FIG. 2 is a circuit diagram of a phase-controlled AC voltage stabilizing circuit of the invention.

FIG. 3 is a circuit diagram showing current flowing directions of input power within the positive half cycle according to the invention.

FIG. 4 is a circuit diagram showing current flowing directions of input power within the negative half cycle.

FIG. 5 is a diagram schematically showing signals triggered by the PWM control device and one-way conduction path according to the invention.

FIG. 6 is a diagram schematically showing waveforms of the exciting voltage and current of the transformer according to the invention.

FIG. 7 is a circuit diagram of the low-pass filter according to one embodiment of the invention.

### DETAILED DESCRIPTION OF THE PREFERRED EMBODIMENTS

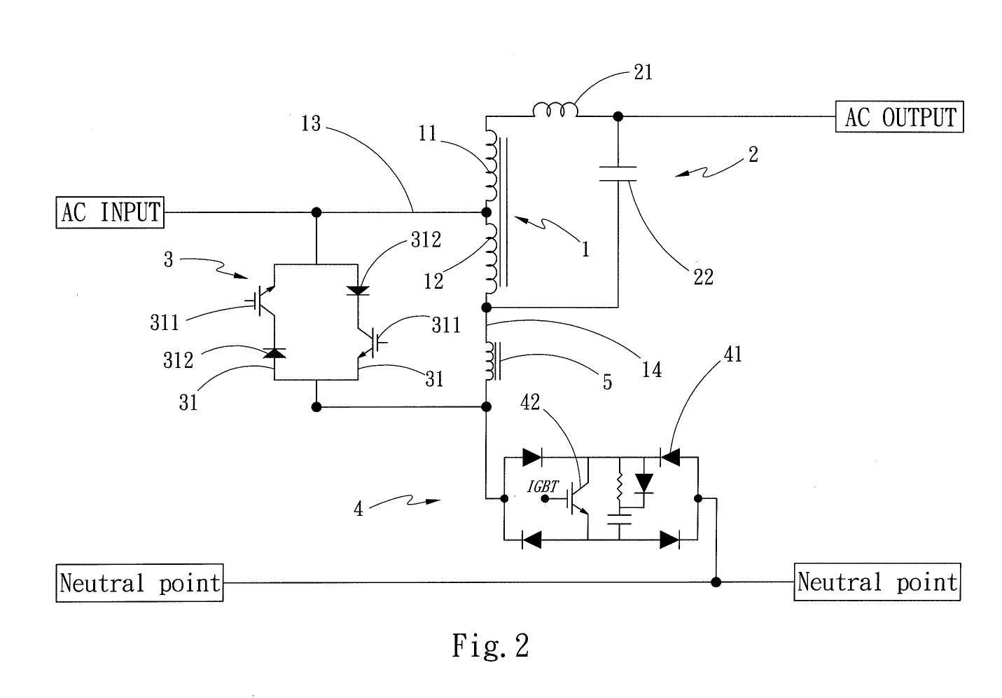

Please refer to FIG. 2, the present invention aims to provide a phase-controlled AC voltage stabilizing circuit which includes a transformer 1, a low-pass filter 2, a buffer device 3, a PWM control device 4 and an inductor 5.

The transformer 1 receives input power and is an auto-transformer with a load side coil 11 and a power side coil 12 on a common iron core.

The low-pass filter 2 receives output power from the transformer 1, and includes an inductor 21 and a capacitor 22. The inductor 21 receives the output power and the capacitor 22 filters out high frequency harmonic to output power for utilization.

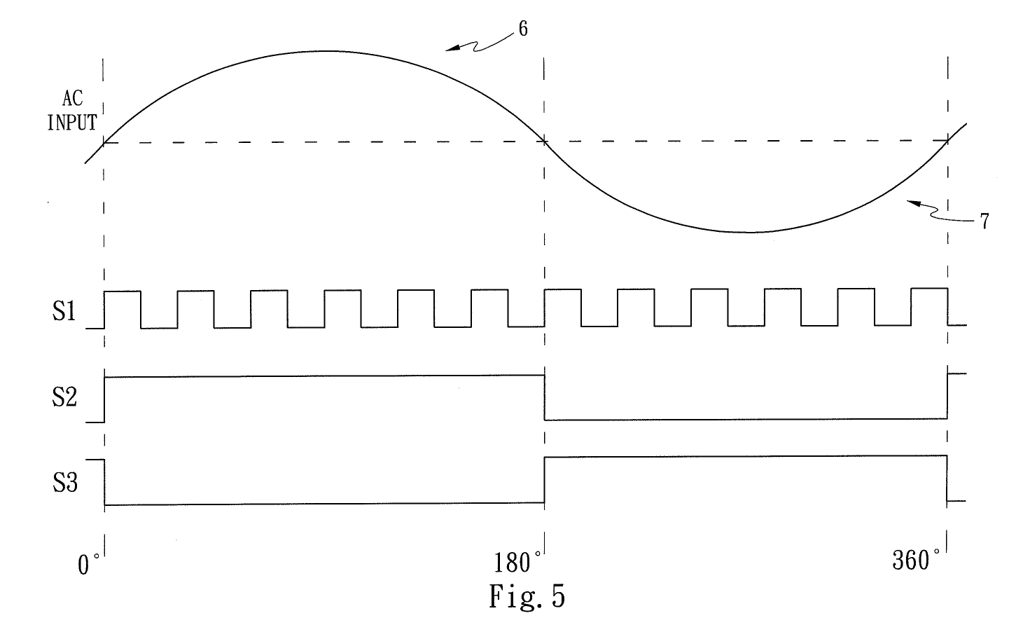

Referring to FIGS. 2 and 5, the buffer device 3 is connected between the input power side 13 of the transformer 1 and exciting side 14 of the transformer 1, and includes two one-way conduction paths 31 that are in opposite conductive directions. When one one-way conduction path is set ON, the other one-way conduction path is set OFF to respectively provide a flywheel path of exciting current within the positive half cycle 6 and negative half cycle 7 for the transformer 1. The one-way conduction path 31 includes at least one controllable switch 311 and at least one one-way conduction device 312 coupled in series. The one-way conduction device 312 includes a plurality of power diodes coupled together (not shown in the drawings).

The PWM control device 4 is connected between the buffer device 3 at the exciting side 14 of the transformer 1 and a neutral point of a power supply system, and is a semiconductor two-way switch including four one-way conduction elements 41 and a controllable switch 42 to switch ON and OFF a number of times within each half cycle of the input power. Each one-way conduction element 41 is a diode.

The inductor 5 is connected between the exciting side 14 of the transformer 1 and the buffer device 3 to smooth exciting current waveform of the transformer 1 and also reduce current harmonic of the input power and voltage harmonic of the output power of the transformer 1.

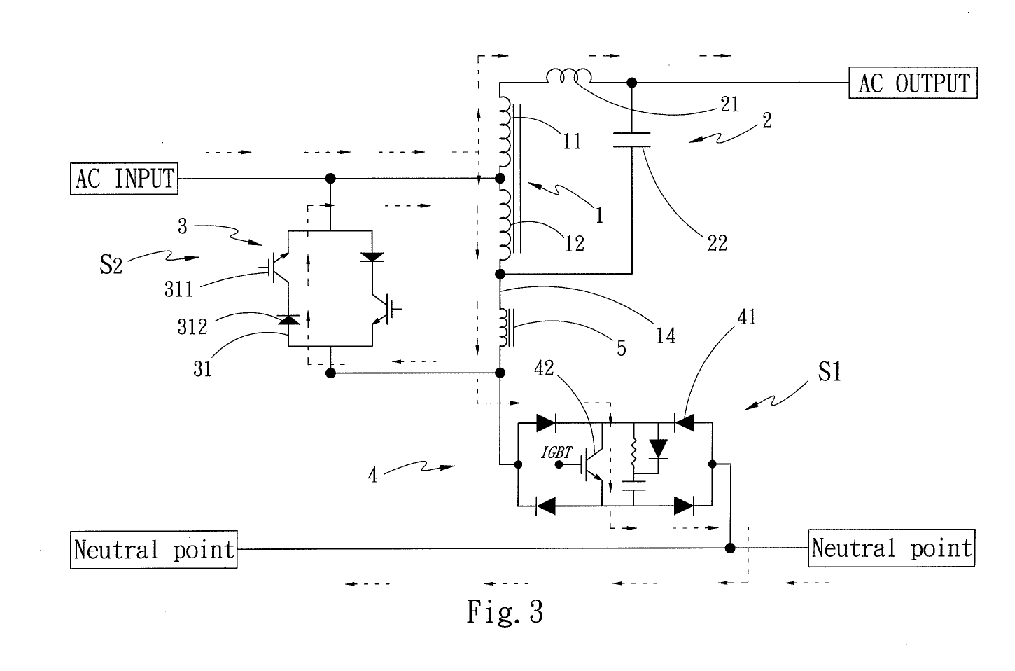

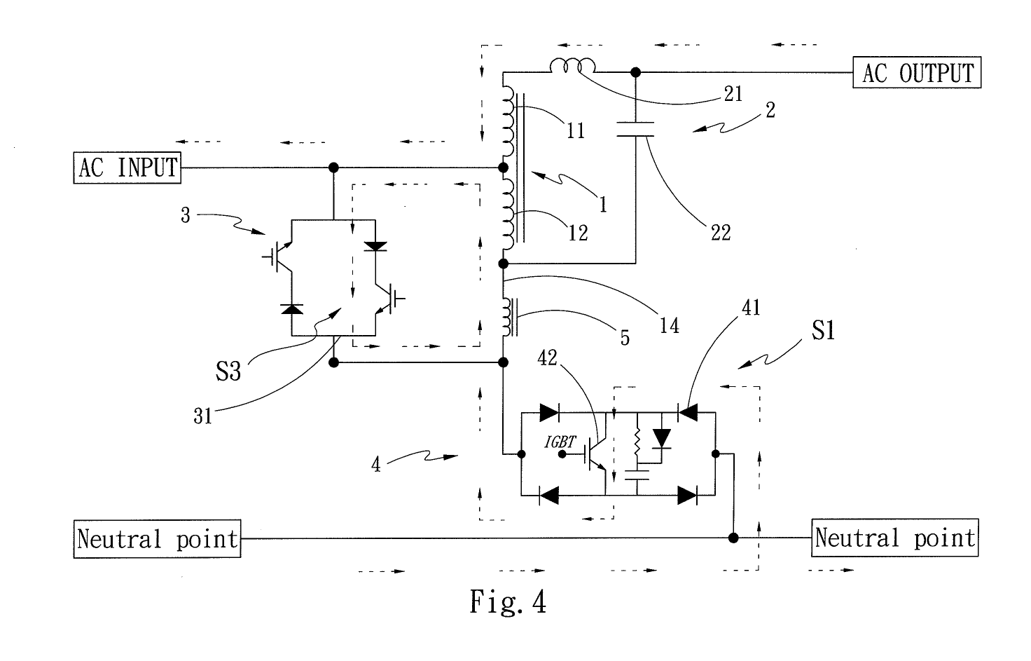

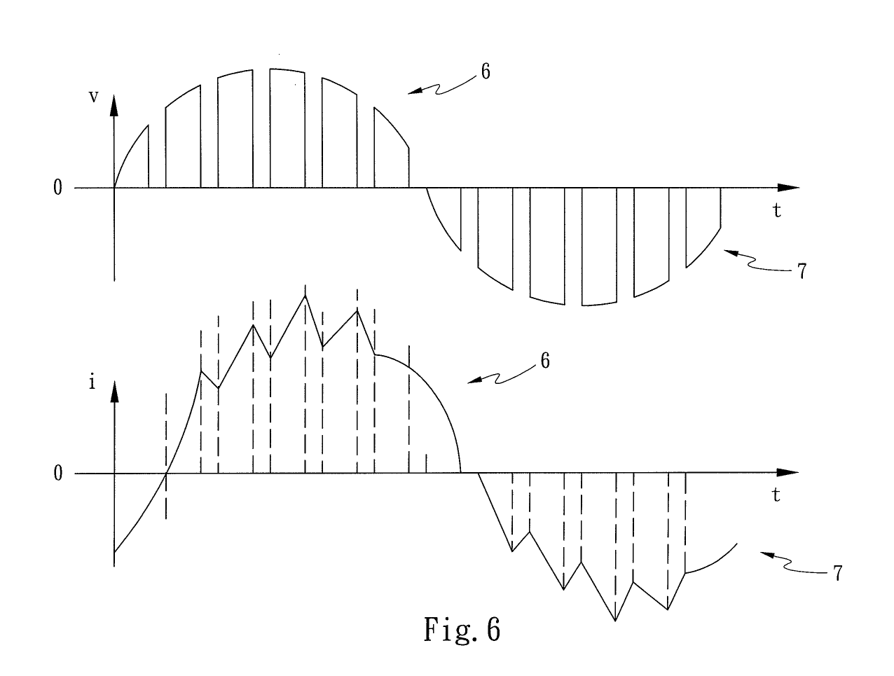

Referring to FIG. 2, during operation, the input power passes through the one-way conduction path 31 of the buffer device 3, and allows the PWM control device 4 to be switched ON and OFF a number of times within each half cycle, therefore the voltage at the exciting side 14 of the transformer 1 is regulated to be a variable voltage with several stages. The variable voltage is filtered by the inductor 5 so that the exciting current waveform of the transformer 1 is smoother. Through coupling the power side coil 12 to the load side coil 11, output voltage of the transformer 1 can be regulated. Moreover, the inductor 21 and capacitor 22 of the low-pass filter 2 can filter out high frequency harmonic to output power for utilization. The PWM control device 4 employs high frequency control to result in fast response time of voltage regulation and reduce distortion of the output voltage waveform, and also diminish the size and weight of the low-pass filter 2. Also referring to FIGS. 3, 5 and 6, during the positive half cycle 6 of the input power, the flywheel path provided by the one-way conduction path 31 has a second operating time series S2 and is set ON and OFF consecutively a number of times through the PWM control device 4, therefore the voltage at the exciting side 14 of the transformer 1 is regulated to a variable voltage with several stages to smooth the exciting current and reduce distortion of the output voltage waveform of the transformer 1. The PWM control device 4 has a first operating time series S1 for the input power. Referring to FIGS. 4, 5 and 6, during the negative half cycle 7, the flywheel path provided by the one-way conduction path 31 has a third operating time series S3 and is set ON and OFF consecutively a number of times through the PWM control device 4, therefore the voltage at the exciting side 14 of the transformer 1 is regulated to a variable voltage with several stages to allow the voltage to be stabilized quickly.

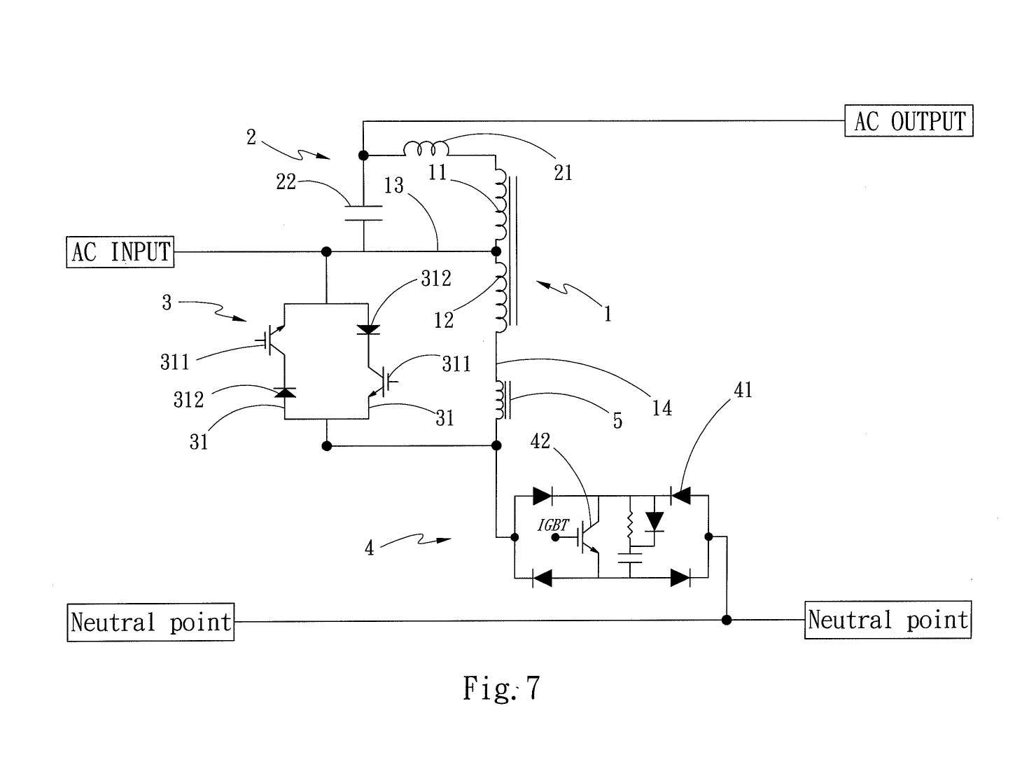

Refer to FIG. 7 for one embodiment of the low-pass filter 2. The low-pass filter 2 is merely connected to the load side coil 11 of the transformer 1.

What is claimed is:

1. A phase-controlled AC voltage stabilizing circuit, comprising:
a transformer receiving input power;
at least one low-pass filter receiving output power from the transformer and filtering out harmonic of the output power;
a buffer device connected between an input power side and an exciting side of the transformer and including two one-way conduction paths that are in opposite conductive directions, each one-way conduction path including at least one controllable switch and at least one one-way conduction device coupled in series; and
a pulse width modulation control device which in connected between the buffer device at the exciting side of the transformer and a neutral point of a power supply system and is a semiconductor two-way switch for switching ON and OFF a plurality of times within each half cycle of the input power.

2. The phase-controlled AC voltage stabilizing circuit of claim 1 further including an inductor which is connected between the exciting side of the transformer and the buffer device to reduce current harmonic of the input power and voltage harmonic of the output power of the transformer.

3. The phase-controlled AC voltage stabilizing circuit of claim 1, wherein the transformer is an auto-transformer.

4. The phase-controlled AC voltage stabilizing circuit of claim 1, wherein the low-pass filter includes an inductor to receive the output power and a capacitor to filter out the harmonic.

5. The phase-controlled AC voltage stabilizing circuit of claim 1, wherein the pulse width modulation control device is a semiconductor two-way switch including four one-way conduction elements and a controllable switch coupled together.

6. The phase-controlled AC voltage stabilizing circuit of claim 5, wherein each of the one-way conduction elements is a diode.

7. The phase-controlled AC voltage stabilizing circuit of claim 1, wherein the one-way conduction device includes a plurality of power diodes coupled together.
